(19) United States
(12) Patent Application Publication
(10) Pub. No.: US 2010/0075110 A1
(43) Pub. Date: Mar. 25, 2010

(54) Electrocast Sticker

(76) Inventor: Ming-Chung Pan, Dali City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/235,685

(22) Filed: Sep. 23, 2008

(51) Int. Cl. B32B 3/00; B32B 3/10; B32B 15/00

(52) U.S. Cl. 428/172; 428/209; 428/457

(57) ABSTRACT

The present invention discloses an electrocast sticker with colors sprayed and printed on a surface of the electrocast sticker. After a cast object is deposited and formed, a non-contact spray printing technology is used for spray printing a pattern and a color directly on a surface of the cast object to produce a text and a pattern with a metal lust and color effect.

### FIELD OF THE INVENTION

The present invention relates to an electrocast sticker (or an electrocast name plate), and more particularly to an electrocast sticker (or electrocast name plate) having a surface with colors sprayed and printed by a non-contact method to give an electrocast sticker with metal lust and color.

### BACKGROUND OF THE INVENTION

Electrocast sticker (or electrocast name plate) comes with the effect of a pure metal and a high lust, and thus it is used extensively in high-end products, not only serving as a trademark, but also improving the high-quality texture of the product. Therefore, the electrocast sticker (or electrocast name plate) is primarily applied for manufacturing a trademark, a name plate or a pattern of a high-end product such as a notebook computer, a mobile phone, a stereo, an art craft, a machine or a piece of furniture, etc. The electrocast sticker is used in a way similar to a general sticker, and users simply tear off the sticker and stick it directly on a product, and thus the application is very simple and easy, and its use is very popular.

With reference to FIGS. 8 and 9 for a manufacturing flow of a general electrocast sticker (or electrocast name plate), a trademark is drafted and designed, and then a female die 40 is produced, and the drafted trademark is transferred and printed on the electrically conducting female die 40, such that the trademark has a blank conducting area 41, and a non-conductive area 42 disposed at a position other than the position of the trademark for printing an insulated coating layer thereon, and the completed female die 40 is dipped into a cathode electrocasting tank and an anode electrocasting tank for consuming and releasing metal, and the metal ions are attached in a conducting area 41 of the cathode female die 40, and the metal is deposited gradually to an appropriate thickness, and then a cast object 50 of a pure metal is deposited in the conducting area 41 (as shown in FIG. 10), and an electroplated layer made of a tin-cobalt alloy is formed on a surface of the cast object 50 for protecting the cast object 50 and enhancing the resistance to corrosions and the lust of the surface. A transparent transfer sticker 61 with an appropriate adhesiveness is coated onto the female die 40, and the cast object 50 is separated from the female die 40 and adhered to the transfer sticker 61 (as shown in FIG. 11), and a glue is applied onto the backside of the transfer sticker 61 and attaching a substrate paper to form a sheet shaped electrocast sticker (or electrocast name plate), and the whole piece of electrocast sticker is cut into pieces of finished goods of electrocast stickers (or electrocast name plates), so that users can tear off the electrocast sticker and stick the electrocast sticker onto a product similarly to a general sticker, and the application is very convenient and quick.

However, colors cannot be printed on the surface of the conventional electrocast sticker (or electrocast name plate), and thus the prior art can have a single color of metal and cannot provide a color effect. Therefore, the electrocast sticker is not only applied for texts only. In other words, the prior art can be used for a general text trademark, machine or electrocast name plate, but not for a color text trademark or pattern trademark.

The main reason of the electrocast sticker (or electrocast name plate) being unable to be printed with colors resides on that a pure metal is deposited onto a female die 40 of the cast object 50 by the principle of electrolysis, and the cast object 50 comes with a limited adhesiveness. If the female die 40 with the attached cast object 50 is placed onto a printing machine, the vibrations caused by the printing machine holding the female die 40 and the conveying and transfer of the female die 40 on the printing machine will cause the cast object 50 to fall off from the female die 40, and the printing machine will be unable to print colors onto the cast object 50. Furthermore, an English trademark on the cast object 50 is composed English words, and such English words wall off from the cast object 50 makes the situation more difficult or impossible for the printing. The cast object 50 is usually made of a metal, such that if the cast object 50 is placed on a roller of the printing machine to press the female die 40, the produced pressure will separate the cast object 50, and thus the cast object 50 cannot be printed. All of the above are the main reasons that the cast object 50 cannot be printed with colors.

### SUMMARY OF THE INVENTION

Therefore, it is a primary objective of the present invention to provide an electrocast sticker, wherein a cast object is deposited and formed, and then a non-contact spray printing technology is used for spray printing a pattern and a color directly onto a surface of the cast object to produce the electrocast sticker having a text and a pattern with metal lust and color effects.

In the present invention, a non-contact spray printing technology is used for spray printing a pattern or a color directly onto a surface of the cast object, and thus the invention breaks through the technology of a traditional metal cast object that cannot be printed with color, and improves the scope of application of the cast object, so that the electrocast sticker (or electrocast name plate) can be spray printed with color pattern, text or their combination.

### BRIEF DESCRIPTION OF THE DRAWINGS

FIG. 1 is a manufacturing flow chart logical line

FIG. 2 is a perspective view of a female die logical line

FIG. 3 is a schematic view of a portion of a cast object formed by deposition in accordance with the present invention;

FIGS. 4 and 5 are schematic views of a logical line in accordance with the present invention;

FIG. 6 is a schematic view of a logical line with a line running blink effect in accordance with the present invention;

FIG. 7 is a schematic view of a cast object with a logical line in accordance with a preferred embodiment of the present invention;

FIG. 8 is a manufacturing flow chart of a conventional electrocast sticker;

FIG. 9 is a perspective view of a female die for an electrocast sticker in accordance with a prior art;

FIG. 10 is a schematic view of a cast object deposited in a conducting area in accordance with a prior art; and

FIG. 11 is a schematic view of a cast object separated from a female die and attached onto a sticker in accordance with a prior art.

### DETAILED DESCRIPTION OF THE PREFERRED EMBODIMENTS

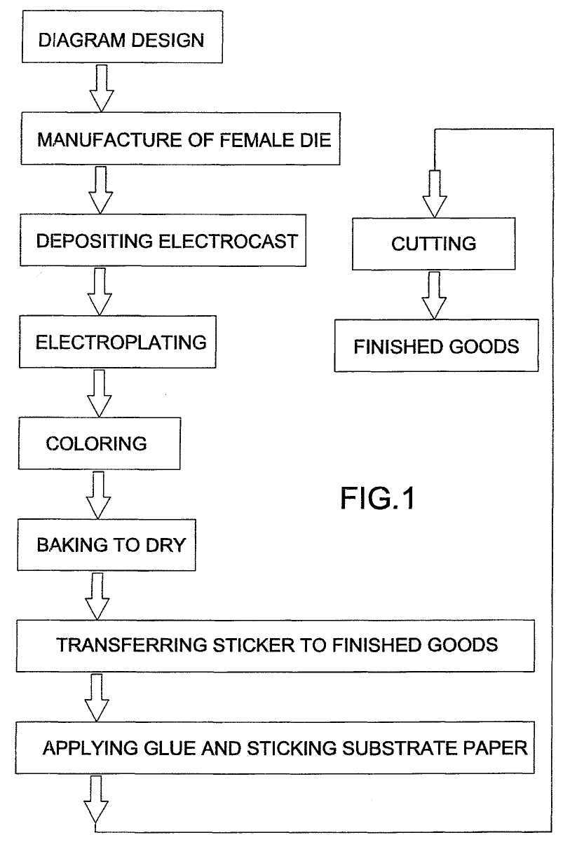

With reference to FIG. 1 for manufacturing a color electrocast sticker (or an electrocast name plate) of the present invention, the color electrocast sticker comprises:

1. Diagram Design: The text, figure, trademark, pattern and diagram design are designed and edited by computer software.

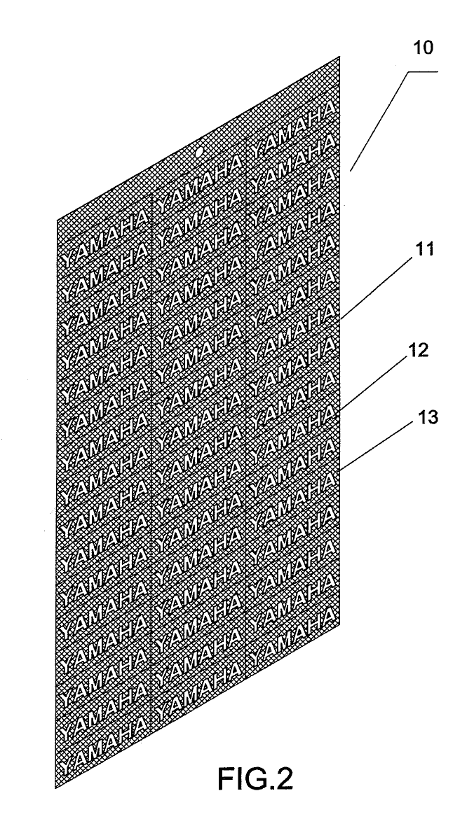

2. Manufacture of Female Die: With reference to FIG. 2, the female die 10 is manufactured by transferring an external frame of a pattern or text onto a template 11, and a conducting area 12 is disposed at a position of a blank figure, and the area printed with a base coating paint is a non-conductive area 13.

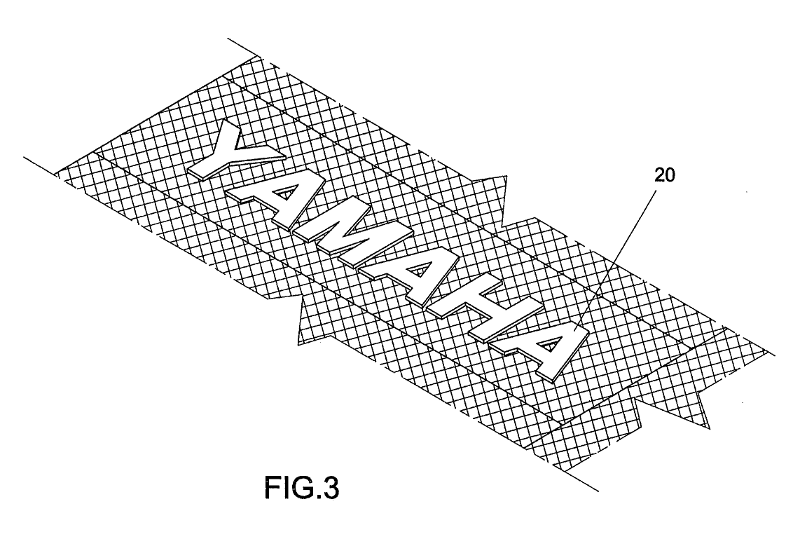

3. Depositing Electrocast: The female die 10 is placed in an electrocast tank connected to a cathode of power supply for performing an electrocast deposition together with a metal electrocast tank connected to an anode at appropriate voltage, current and temperature, and the metal ions consumed at the anode flow towards the female die 10 at the cathode, and are deposited on the blank conducting area 12 to form a cast object 20 having the pattern or text and with a pure metal as shown in FIG. 3.

4. Electroplating: A general electroplating principle is used for plating a tin-cobalt alloy (or trivalent chromium or hexavalent chromium) on a surface of the cast object 20 to improve the corrosion resistance and surface lust of the cast object 20 and extend the using life.

5. Coloring: A non-contact spray printing procedure is carried out to the cast object 20 when the female die 10 is placed into a spray printing machine such as an ink-jet printer, a color spray printer or any other non-contact ink (paint) spraying machine. Based on a diagram draft file, the pattern and color are spray printed directly on a surface of the cast object 20 through the connection of a computer. Since the spray printing is performed by a non-contact method, a very small stress is exerted onto the cast object 20, and the stress of the spray printing is much smaller than the adhesive force of the cast object 20, therefore the cast object 20 will not fall off, so that colors can be sprayed at appropriate positions on the surface of the cast object 20 to provide color layers and diversified colors or patterns, and the cast object 20 not only comes with a metal lust, but also gives a perfect trademark pattern by means of the color spray printing.

6. Baking to Dry: After the surface of the cast object 20 is sprayed, the surface is dried by a baking equipment for drying and solidifying the dye of the figure on the surface.

7. Transferring Sticker to Finished Goods: A transparent adhesive transfer sticker is attached onto the surface between the female die 10 and the cast object 20, and the sticker is separated from the female die 10 and attached onto the transfer sticker after the cast object 20 is separated from the female die 10.

8. Applying Glue and Sticking Substrate Paper: Glue is applied on the backside of the transfer sticker, and the cast object 20, and attach it onto the substrate paper to form a sheet shaped electrocast sticker.

9. Cutting: The sheet shaped electrocast sticker is cut into a multiple of electrocast stickers according to actual needs.

10. Finished Goods: The multiple of electrocast stickers are the finished goods, and users can use the finished good in the same way of a general sticker, and attach the sticker onto a product. The application is very convenient and quick.

Performing a Surface Coating Treatment

Before the cast object 20 is colored, the surface of the cast object 20 is coated with a thin transparent metal surface processing agent by a coating method or a screen printing method as an interface paint for improving the ink adhesiveness at the surface of the cast object 20, or a rough surface treatment is processed to the cast object 20 for improving the adhesiveness of the ink in order to carry out the coloring procedure successfully, or a nano coloring dye is used for attaching the ink dye on to the surface of the cast object 20 without going through the foregoing process of coating an interface coating layer.

Performing a Scent Surface Coating Treatment

In general, the cast object 20 is usually applied to daily products such as the trademarks of a notebook computer, a mobile phone or a stereo, an art craft and mobile phone hanging decoration, etc. If the trademark or art craft has a good smell, then the willingness of purchasing the products will be stimulated or the add-on value of the products will be increased. Before the coloring process of the cast object 20, a thin transparent essence or scent layer is coated on a surface of the cast object 20 by a coating or screen printing method, and the essence can be essence extracted from natural flowers, fruits, fruit peels, natural timber (such as sandal wood or cypress) and chemical synthesized scents, so that the trademark or art craft will come with a scent. Different essences or scents can be provided according to the user preference, and thus the add-on value of the product is improved. The sprayed or printed essence or scent can last for more than one year, but the concentration can be adjust to extend the life to over two years to comply with the using life of the product.

Selecting a Baking Operation

In the baking process, a natural baking method can be used, a compulsory convection or a baking equipment can be used to achieve the baking to dry effect as well.

However, the baking process or equipment of the baking operation is preferably selected according to the type of the ink used.

1. Alcohol Soluble Ink:

The ink used for spray printing is usually an alcohol soluble ink, and any type of baking method including the natural baking, compulsory convection or heating method can be used.

2. Ultraviolet (UV) Ink:

If a UV ink used for spray printing cannot be precipitated and the particle of the dye is very small, then the baking equipment used for the printed text or pattern varies. It is necessary to use different baking equipment such as a UV lamp and a UV baking equipment for producing UV lights or an infrared baking equipment for heating.

Construction Method of Producing 3D Effect

If the electrocast sticker (or electrocast name plate) has a pattern design, it may require a 3D effect. After the metal surface treatment is processed on the surface of the cast object 20, a transparent resin layer with an appropriate thickness is coated on a surface of the cast object 20 according to the position specific in the design drawing. If the transparent resin layer is coated on a text or a figure on a plane, then the text or the figure will reflect lights to provide a 3D design. If the transparent resin layer is coated with 3D layers, then a color ink is spray printed color to provide the 3D effect with different color layers.

After the transparent resin layer is dry and solidified, the transparent resin layer will have a hardening effect to form a hard protecting layer and give a scratch-resisting function to assure the metal lust on the surface of the cast object and improve the life expectancy of the product.

Embodiment of Logical Light Line Effect

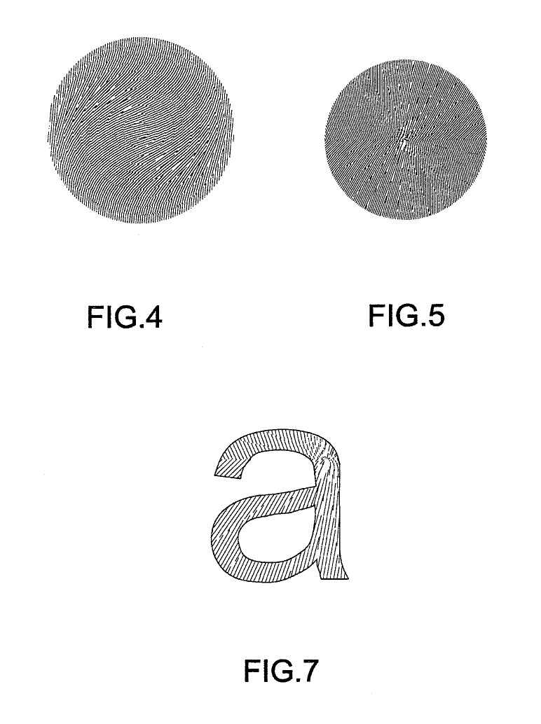

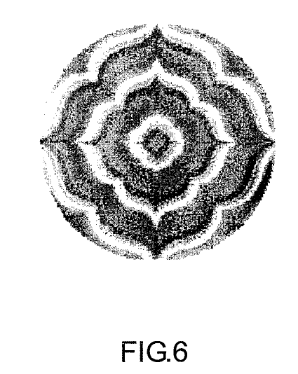

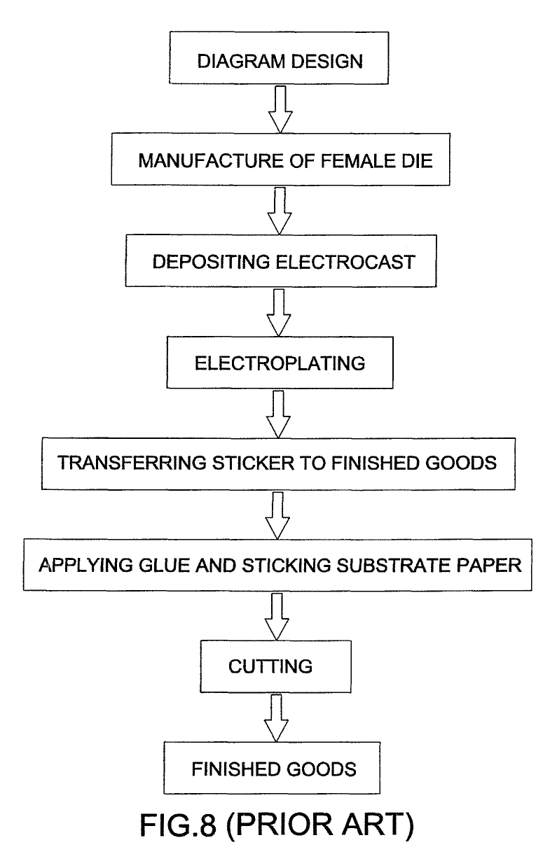

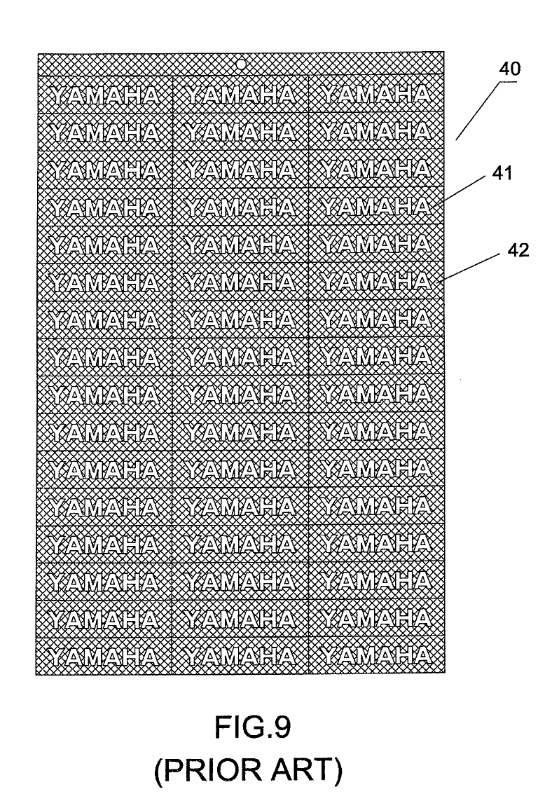

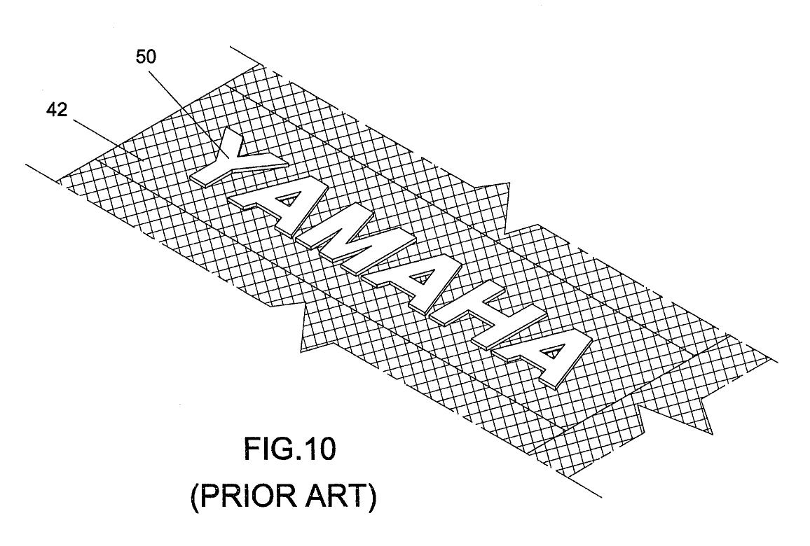

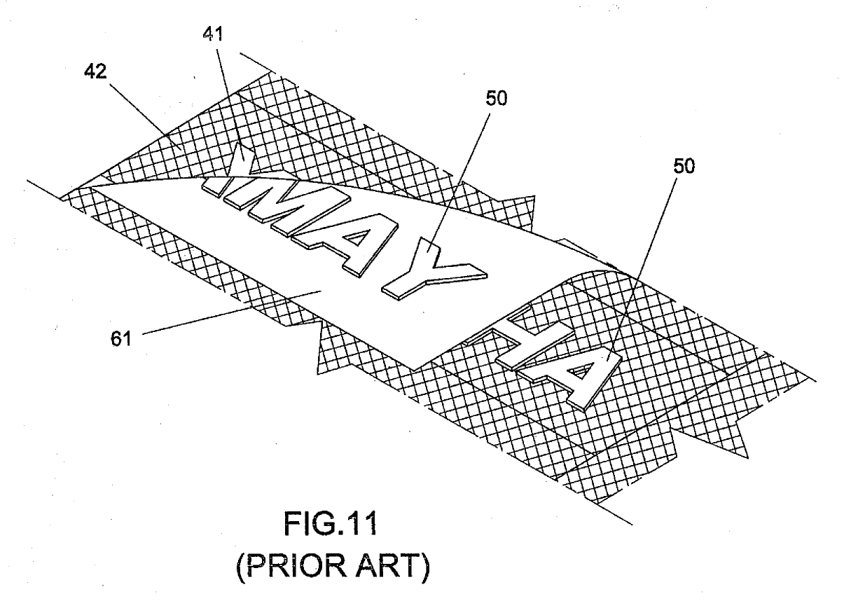

The logical light lines are bright and beautiful with a series of reflective colors at different angles to show the effect of a running blinking line, such as a gold or silver color blinking surface with pressed line or figure processing, such that lights can be reflected to achieve the effect of the running blinking line as shown in FIGS. 4 and 5. The figure does not have the reflective effect as shown in FIG. 6, but it has the pattern arrangement with the reflective effect.

The electrocast sticker is formed and electrocast by a pure metal with a light lust, and thus the characteristic of reflective lines is applied on the surface of the cast object to provide the logical light line and produce the effect of the running blinking line, so as to improve the add-on value of the product. With reference to FIG. 1, an appropriate logical line is sued in a drawing draft when the drawing draft is designed, such that the drawing draft can be exposed into a film for manufacturing the female die, as shown in the enlarged view of the text depicted in FIG. 7, and the lines are very fine, and they are conductive lines. When the electrocast is deposited, a metal is deposited on the logical line to produce a protruding effect, and the blank area without any line will be a recessed area, such that the logical line of the metal cast object can have the lust. In addition, the reflection of lights can give the effect of a running blinking line.

Anti-Counterfeit Effect

The electrocast sticker (or electrocast name plate) is manufactured according to a pattern designed by a computer, such that after the female die 10 is completed, the film can be produced, and the pattern of the film can be used as a basis of comparison and serves as an anti-counterfeit effect.

Broad Scope of Applicability

Various text or pattern trademarks of the electrocast stickers can be produced, and the text and pattern of the electrocast sticker can be combined with the model number or the electrocast name plate for different commercial purposes, and the stickers can be attached onto different products to enhance the quality and texture of the products.

In summation of the description above, the non-contact spray method is used for spray printing colors on the cast object of the female die to give the color trademark or pattern with a metal lust, so as to provide a high quality electrocast sticker with good texture, and the cast object can be designed with 3D layers according to the design diagram to match the colors for a prominent 3D pattern, so that a more lively pattern design of the electrocast sticker can be used for the color text, trademark or pattern. The invention breaks through the traditional manufacturing process, and complies with the requirements for patent application, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A color electrocast sticker, comprising a metal cast object formed by an electrocast deposition, characterized in that a pattern or a color layer is formed on a surface of the cast object by spray printing.

2. The color electrocast sticker of claim 1, further comprising a tin-cobalt alloy layer formed between the cast object and the color layer by electroplating.

3. The color electrocast sticker of claim 1, wherein the color layer is formed on the surface of the cast object by a non-contact spray printing method.

4. The color electrocast sticker of claim 1, further comprising an interface coating layer coated between the cast object and the color layer.

5. The color electrocast sticker of claim 1, wherein the cast object is processed by a rough surface treatment to enhance the pigment adhesiveness of an ink.

6. The color electrocast sticker of claim 1, wherein the interface coating layer adopts a screen printing with a low contact pressure.

7. The color electrocast sticker of claim 1, wherein the color layer is formed by spray printing a nano ink.

8. The color electrocast sticker of claim 1, further comprising a transparent resin layer having an uneven thickness and coated between the cast object and the color layer to produce a color texture with different layers.

9. The color electrocast sticker of claim 1, further comprising a transparent thin essence layer or scent layer coated between the cast object and the color layer.

10. The color electrocast sticker of claim 1, wherein the essence or scent coating layer is coated by screen printing with a low contact pressure.

11. The color electrocast sticker of claim 1, wherein the essence or scent coating layer is coated by spray printing.

12. The color electrocast sticker of claim 1, wherein an appropriate logical line is applied to a diagram draft which is exposed to form a film to produce a female die when the diagram draft is designed, and the line is in a form of a conducting line for centralizing and depositing a metal onto the logical line to form the cast object with the logical line and the lust metal, when the electrocast is deposited.

13. The color electrocast sticker of claim 1, wherein the color electrocast sticker is applied to an electrocast name plate.
